(19) United States
(12) Patent Application Publication
(10) Pub. No.: US 2004/0214581 A1
(43) Pub. Date: Oct. 28, 2004

(54) Selecting an operation mode for a device connected to a network

(76) Inventors: Gregory G. Davis, Monument, CO (US); Mark W. Gallagher, Colorado Springs, CO (US); Robert W. Bytheway, Colorado Springs, CO (US)

Correspondence Address: Timothy N. Trop, TROP, PRUNER & HU, P.C., STE. 100, 8554 KATY FWY, HOUSTON, TX, 77024-1841, US

(21) Appl. No.: 10/421,099

(22) Filed: Apr. 23, 2003

(51) Int. Cl. H04Q 7/32

(52) U.S. Cl. 455/452.2; 455/557; 455/414.1

(57) ABSTRACT

In one embodiment of the present invention, a method includes connecting a wireless device to a network via a first connection and enabling a lower usage level for the wireless device if a throughput of the first connection is below a predetermined threshold.

### BACKGROUND

Various networks may be used to connect data processing devices existing at different locations. For example, wired networks exist to connect computers together within a work environment, between homes and the Internet and the like. Additionally, wireless networks exist to permit wireless devices to communicate with each other or wired devices.

In modern networks, it is typically desired to have high bandwidths to enable large amounts of data to be transmitted quickly. Where bandwidth limitations exist or where bottlenecks in a network such as high latencies are present, data flow may be impaired. This impairment may cause applications run on various devices to operate undesirably slow or to fail entirely.

Such impairments exist particularly in low bandwidth wireless networks such as a wireless wide area network (WWAN) or a wireless local area network (WLAN). Thus a need exists to permit devices connected to a network to communicate effectively even in low bandwidth or high latency conditions.

### BRIEF DESCRIPTION OF THE DRAWINGS

FIG. 1 is a flow diagram of a method in accordance with one embodiment of the present invention.

FIG. 2 is a block diagram of a network with which embodiments of the present invention may be used.

FIG. 3 is a block diagram of another network with which embodiments of the present invention may be used.

FIG. 4 is a block diagram of a representative data processing system with which embodiments of the present invention may be used.

### DETAILED DESCRIPTION

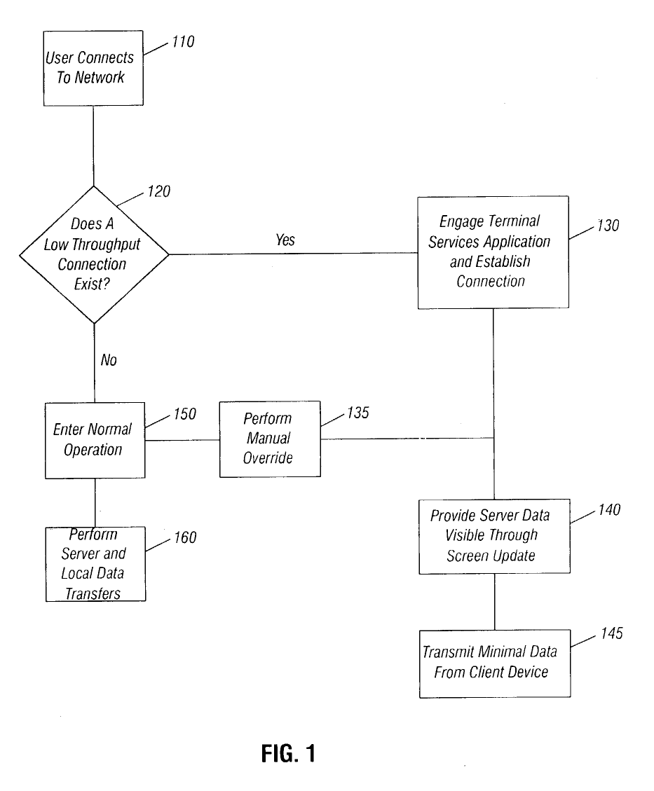

Referring now to FIG. 1, shown is a flow diagram of a method in accordance with one embodiment of the present invention. As shown in FIG. 1, a user connects to a network (block 110). In certain embodiments the network may be a wireless network such as a WLAN or a WWAN. While discussed in FIG. 1 as a wireless network, certain embodiments of the present invention may be used in connection with wired networks having low bandwidth connections or high latencies. More so, while embodiments may be used in connection with various wired or wireless devices, in the embodiment of FIG. 1, a wireless device (e.g., a client device) such as a cellular telephone, personal digital assistant (PDA), notebook personal computer (PC), or the like may be used.

As shown further in FIG. 1, next it may be determined whether the network connection suffers from low throughput (diamond 120). While this determination may be made at various points, in one embodiment the determination may be made on the client device.

The particular type of connection may be part of the determination in certain embodiments. More so, in certain embodiments the application desired to be run by a user of the client device may be considered. Still further in certain embodiments, a user defined profile also may be considered. In various embodiments, based on these considerations it may be determined whether the connection meets a predefined threshold with regard to throughput.

Due to these various factors that may be considered, the determination of what is considered low throughput may vary in different embodiments and thus the predefined threshold may vary. Thus in certain embodiments, various connections slower than a broadband connection, such as a WWAN, WLAN, general packet radio service (GPRS), and the like, may be considered to have low throughput, along with connections such as a modem connection in compliance with the V.90 standard of the International Telecommunication Union (February 1998), or other such connection.

If a network connection is a low throughput connection, in one embodiment a remote terminal services application may be engaged and an appropriate connection established (block 130). As used herein, “terminal services” means an operation mode or usage level of a device that limits either the processing capability of the device or the ability of the device to transfer and/or receive robust data transmissions, or both. For example, a terminal services application may be, for example, an email program in which a remote device (e.g., a server, a personal computer, or the like) performs all program processing, and data transfer between the remote device and the client device may be limited to screen refreshes (i.e., from remote device to client device) and user input information (i.e., from client device to remote device). Such a remote device may be configured to host desired office/enterprise applications and data, and to allow remote terminal services usage. In certain embodiments, software script on the client device may engage the client device into a terminal services application.

Referring again to FIG. 1, during operation a server acting as a remote device may provide data visible to the user of the client device through screen updates (block 140). For example, an enterprise application such as an email program, word processing program or the like may be executed on the server and screen updates may be sent Lo the client device for display on an associated display. Next, a user may edit the document, perform redirection, or another such action via keystrokes, mouse or other user input. This minimal data may be transmitted from the client device back to the remote server (block 145). For example, keystrokes and mouse inputs may be transmitted via a WWAN connection to the server.

In certain embodiments it may be desirable for a user to manually override a terminal services usage level. In such embodiments, a user may perform a manual override (block 135). Such a manual override may allow the user to enter into a normal mode of operation of the client device (block 150). In such manner, data transfer between a server and the client device may include entire files such as word processing documents, presentations, and the like (block 160).

In certain embodiments, usage of protocols such as Remote Desktop Protocol (RDP) or Independent Computing Architecture (ICA) may provide for communication between a client device and a remote server. In such embodiments, these or other similar data transfer protocols may significantly reduce the amount of over the air data traffic in a wireless network. For example, using such protocols only screen (video) refresh (i.e., downstream), and keystrokes and mouse or other user inputs (i.e., upstream) may be transferred.

In certain embodiments, the connectivity technology being used may be intelligently determined. In such embodiments, the usage level of the client device may be automatically switched based on one or more of the network connection, throughput, as well as the application being used. Such automatic switching may be seamless and may be implemented at any time based on then current network conditions. In other embodiments, a user selectable profile may be considered in determining the appropriate usage level. For example, such a user selectable profile may include information such as the type of network being used, the timing required for sending or receiving data, throughput of the connection, network location awareness, and the like.

Instead of automated switching of operation modes, in certain embodiments a user may be advised that a low throughput condition exists, for example, via a graphical user interface. Such an interface may provide a prompt for the user to select and switch to a lower usage level. In still other embodiments, a user may initiate an analysis of network conditions to determine when a change in usage levels is appropriate.

In certain embodiments, a user may engage in standard type office/enterprise applications for review, edit and retransmission of data using a lower bandwidth connection or an impaired higher bandwidth connection. For example, server based data may be effectively received and reviewed in certain embodiments although a low bandwidth connection or condition exists. More so, in certain embodiments costs of over the air service may be minimized.

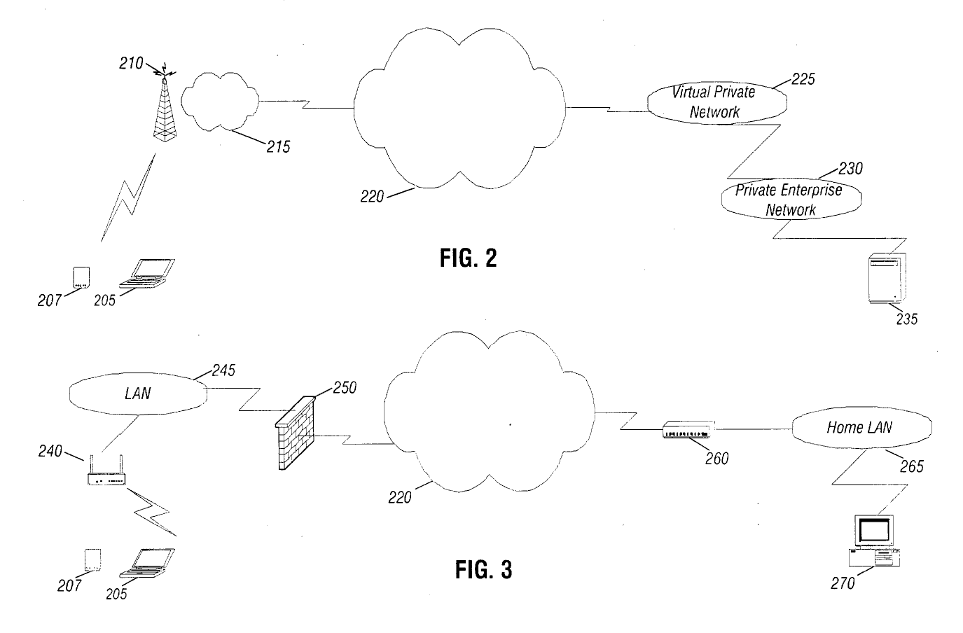

Referring now to FIG. 2, shown is a block diagram of a network having high latency and low bandwidth with which embodiments of the present invention may be used. As shown in FIG. 2, a client device in accordance with one embodiment of the present invention such as a notebook computer 205 or a PDA 207 may communicate wirelessly with a base station 210 of a wireless carrier. From carrier network 215, signals pass via the Internet 220 to a virtual private network (VPN) 225 which may be coupled to a private enterprise network 230 to which is coupled a server 235. Server 235 may store and execute enterprise applications for client devices 205 or 207 while they operate in a terminal services mode. In various embodiments, server 235 may be any commercially available server, and may include conventional components and memory devices such as synchronous dynamic random access memory (SDRAM), static random access memory (SRAM), double data rate (DDR) memory and the like.

Referring now to FIG. 3, shown is a block diagram of another network having high latency and low bandwidth with which embodiments of the present invention may be used. As shown in FIG. 3, notebook computer 205 or PDA 207 which may operate in accordance with an embodiment of the present invention may wirelessly communicate with an access point 240 such as a WLAN or a BLUETOOTH™ access point. In turn access point 240 may be coupled to a local area network (LAN) 245 such as a hotel, customer network or conference LAN for example. In turn LAN 245 may be coupled via a firewall 250 to the Internet 220. From there, signals may be provided to a broadband router 260 and passed to a home LAN 265 and finally to a personal computer 270. In various embodiments personal computer 270 may execute applications on behalf of client devices 205 or 207 while they operate in a terminal services mode. While discussed in this embodiment as being located at a home location of a user, it is to be understood that in other embodiments such a PC may be located in other places such as a workplace or the like.

Embodiments may be implemented in a computer program. As such, these embodiments may be stored on a storage medium having stored thereon instructions which can be used to program a computer system, wireless device or the like to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

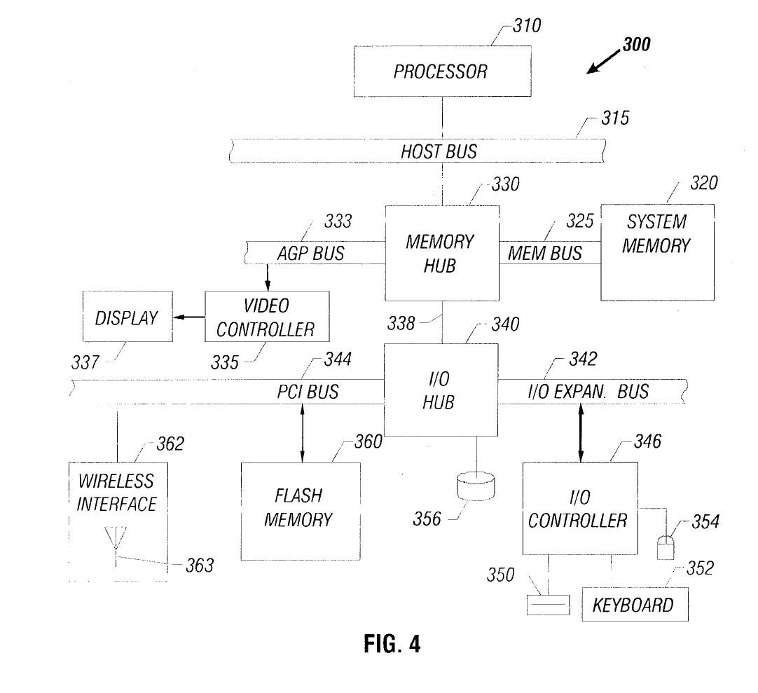

FIG. 4 is a block diagram of a representative data processing system, namely computer system 300 with which embodiments of the invention may be used. In one embodiment, computer system 300 includes a processor 310, which may include a general-purpose or special-purpose processor such as a microprocessor, microcontroller, application specific integrated circuit (ASIC), a programmable gate array (PGA), and the like.

The processor 310 may be coupled over a host bus 315 to a memory hub 330 in one embodiment, which may be coupled to a system memory 320 via a memory bus 325. The memory hub 330 may also be coupled over an Advanced Graphics Port (AGP) bus 333 to a video controller 335, which may be coupled to a display 337. The AGP bus 333 may conform to the Accelerated Graphics Port Interface Specification, Revision 2.0, published May 4, 1998, by Intel Corporation, Santa Clara, Calif.

The memory hub 330 may also be coupled (via a hub link 338) to an input/output (I/O) hub 340 that is coupled to a input/output (I/O) expansion bus 342 and a Peripheral Component Interconnect (PCI) bus 344, as defined by the PCI Local Bus Specification, Production Version, Revision 2.1 dated in June 1995, or alternately a bus such as the PCI Express bus, or another third generation I/O interconnect bus. The I/O expansion bus 342 may be coupled to an I/O controller 346 that controls access to one or more I/O devices. As shown in FIG. 4, these devices may include in one embodiment storage devices, such as a floppy disk drive 350 and input devices, such as keyboard 352 and mouse 354. The I/O hub 340 may also be coupled to, for example, a hard disk drive 356 as shown in FIG. 4. It is to be understood that other storage media may also be included in the system. In an alternate embodiment, the I/O controller 346 may be integrated into the I/O hub 340, as may other control functions.

The PCI bus 344 may be coupled to various components including, for example, a flash memory 360. Further shown in FIG. 4 is a wireless interface 362 coupled to the PCI bus 344, which may be used in certain embodiments to communicate with remote devices. As shown in FIG. 4, wireless interface 362 may include a dipole or other antenna 363 (along with other components not shown in FIG. 4). While such a wireless interface may vary in different embodiments, in certain embodiments the interface may be used to communicate via data packets with a WWAN, WLAN, a BLUETOOTH™ or another wireless access point. In various embodiments, wireless interface 362 may be coupled to system 300, which may be a notebook personal computer, via an external add-in card, or an embedded device. In other embodiments wireless interface 362 may be fully integrated into a chipset of system 300.

Although the description makes reference to specific components of the system 300, it is contemplated that numerous modifications and variations of the described and illustrated embodiments may be possible. More so, while FIG. 4 shows a block diagram of a system such as a notebook personal computer, it is to be understood that embodiments of the present invention may be implemented in another wireless device such as a cellular phone, PDA or the like. In such embodiments, a flash memory in accordance with an embodiment may be coupled to an internal bus which is in turn coupled to a microprocessor and a peripheral bus, which may in turn be coupled to a wireless interface and an associated antenna such as a dipole antenna, helical antenna, global system for mobile communication (GSM) antenna, and the like.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a lower usage level for a wireless device coupled to a network via a first connection, if a throughput of the first connection is below a predetermined threshold.

2. The method of claim 1, further comprising providing a manual override of the lower usage level.

3. The method of claim 1, wherein the first connection comprises a wireless wide area connection.

4. The method of claim 1, wherein the lower usage level comprises a terminal services usage level.

5. The method of claim 4, wherein enabling the terminal services usage level comprises executing script to establish the terminal services usage level.

6. The method of claim 4, further comprising manually switching from the terminal services usage level to a normal mode of operation for data transfer with the network.

7. A method comprising:
selecting a usage level for a client device coupled to a remote device via a network connection based at least in part on a throughput level of the network connection.

8. The method of claim 7, wherein selecting the usage level comprises selecting between a normal mode and a terminal services mode of the client device.

9. The method of claim 7, further comprising automatically switching the client device to the usage level after selecting the usage level.

10. The method of claim 9, further comprising manually overriding the usage level via the client device.

11. The method of claim 7, further comprising selecting the usage level based at least in part on user profile information.

12. The method of claim 7, further comprising selecting the usage level based at least in part on a desired application.

13. The method of claim 7, wherein the remote device comprises a server and the network connection comprises a wireless wide area connection.

14. The method of claim 7, further comprising permitting a user of the client device to switch to the usage level.

15. A system comprising:
at least one storage device to store code to select a usage level for a client device coupled to a remote device via a network connection based at least in part on a throughput level of the network connection; and
a dipole antenna coupled to the at least one storage device.

16. The system of claim 15, wherein the at least one storage device comprises a flash memory.

17. The system of claim 16, further comprising a wireless interface coupled to the dipole antenna, the wireless interface to communicate with a wireless access point.

18. The system of claim 15, wherein the network connection comprises a wireless wide area network connection.

19. An article comprising a machine-readable storage medium containing instructions that if executed enable a system to:
select a lower usage level for a wireless device connected to a network via a first connection if a throughput of the first connection is below a predetermined threshold.

20. The article of claim 19, further comprising instructions that if executed enable the system to provide for a manual override of the lower usage level.

21. The article of claim 19, further comprising instructions that if executed enable the system to select the lower usage level based at least in part on user profile information.

22. The article of claim 19, further comprising instructions that if executed enable the system to select the lower usage level based at least in part on a desired application.

23. An apparatus comprising:
at least one storage device to store code to cause a remote device coupled to a client device via a network connection to execute an application for the client device if a lower usage level is selected for the client device based at least in part on a throughput level of the network connection.

24. The apparatus of claim 23, wherein the remote device comprises a server.

25. The apparatus of claim 24, wherein the server is coupled to the client device via a private enterprise network.

26. The apparatus of claim 23, wherein the at least one storage device comprises a dynamic random access memory.
